(19) United States
(12) Patent Application Publication
(10) Pub. No.: US 2013/0284102 A1
(43) Pub. Date: Oct. 31, 2013

(54) Insulated Animal Drinking Bowl

(71) Applicant: Marianne Parisi McCune, Ashtabula, OH (US)

(72) Inventor: Marianne Parisi McCune, Ashtabula, OH (US)

(21) Appl. No.: 13/862,663

(22) Filed: Apr. 15, 2013

Related U.S. Application Data
(60) Provisional application No. 61/639,238, filed on Apr. 27, 2012.

(51) Int. Cl. A01K 7/00

(52) U.S. Cl. CPC A01K 7/00
USPC 119/72

(57) ABSTRACT

The subject matter disclosed and claimed herein, in one aspect thereof, is a portable, insulated animal drinking container that reduces the likelihood that the container contents will freeze, and that does not require an external heating or power source. In a preferred embodiment of the present invention, the portable, insulated drinking container comprises an outer container, an inner container, an insulating material positioned between said outer container and said inner container and a cover with a continuous opening therein to enable the animal to access the contents on the inner container without disturbing the insulating material. The insulating materials may be comprised of organic or inorganic insulating materials, or a combination thereof.

### CROSS-REFERENCE

This application claims priority from Provisional Patent Application Serial No. 61/639,238 filed on Apr. 27, 2012.

### FIELD OF THE INVENTION

This invention relates to an insulated drinking bowl for an animal. The unique design of the insulated drinking bowl reduces the likelihood that the drinking bowl contents will freeze and does not require an external heating or power source.

### BACKGROUND

Many individuals who raise or maintain animals, such as pets and livestock, use drinking bowls or other liquid containing containers to hydrate their animals with, for example, water. Additionally, many of the same individuals house their animals in outdoor structures that may be minimally heated, or without heat altogether. However, in cold conditions (i.e., below freezing) the water and other liquids typically kept in such drinking bowls and containers may freeze, which may prevent the animal from properly hydrating. Prolonged or severe dehydration could result in the illness or even death of the animal.

One effort to overcome the problems associated with freezing water in an animal's drinking bowl is to electrically heat the bowl and the contents contained therein. However, electricity may not always be readily available in remote outbuildings, and can be expensive when it is available. Further, animals tend to chew on the power cords associated with such devices which could create a fire hazard and/or the animal could become electrocuted if it chews through a live cord. The use of a power cord also decreases the portability of the device inasmuch as it must be in relatively close proximity to a power supply. Finally, the combination of electricity and water could present a dangerous environment if not continuously monitored, which is not always possible.

Consequently, there exists in the art a long-felt need for an insulated animal drinking bowl that is useful for reducing the likelihood that the water or other liquid contained therein will freeze when stored in an outbuilding with little or no heat, which could result in the dehydration, illness or death of the animal. There also exists in the art a long felt need for an insulated drinking container that is eco-friendly and not dependent on electricity or some other external heating source, the use of which could be both expensive and dangerous. Further, there is a long felt need in the art for a portable, insulated drinking bowl that is not constrained by power cords, fuel lines and the like. Finally, there is a long-felt need for an insulated animal drinking bowl that accomplishes all of the forgoing objectives and that is relatively inexpensive to manufacture, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is a portable, insulated animal drinking container that reduces the likelihood that the water container contents will freeze and does not require an external heating or power source. In a preferred embodiment of the present invention, the portable, insulated drinking container comprises an outer container, an inner container, an insulating material positioned between said outer container and said inner container and a cover with a continuous opening therein to enable the animal to access the contents on the inner container without disturbing the insulating material.

The unique design of the animal drinking bowl of the present invention is useful for reducing the likelihood that the water or other liquid contained therein will freeze when stored in an outbuilding with little or no heat, which could result in the dehydration, illness or death of the animal being cared for. The drinking bowl is eco-friendly and may use organic insulating materials, such as hay, straw and the like to prevent the contents of the inner container from freezing, or inorganic insulating materials. The portable drinking bowl is not dependent on electricity or some other external heating source, the use of which could be both expensive and dangerous, and its use and portability is not constrained by cords, fuel lines or the like. Finally, the insulated drinking bowl is relatively inexpensive to manufacture, and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the various components of a preferred embodiment of the insulated drinking bowl in a disassembled condition.

FIG. 2 illustrates a perspective view of a preferred embodiment of the insulated drinking bowl in a partially assembled condition.

FIG. 3 illustrates a perspective view of a preferred embodiment of the insulated drinking bowl in a fully assembled condition.

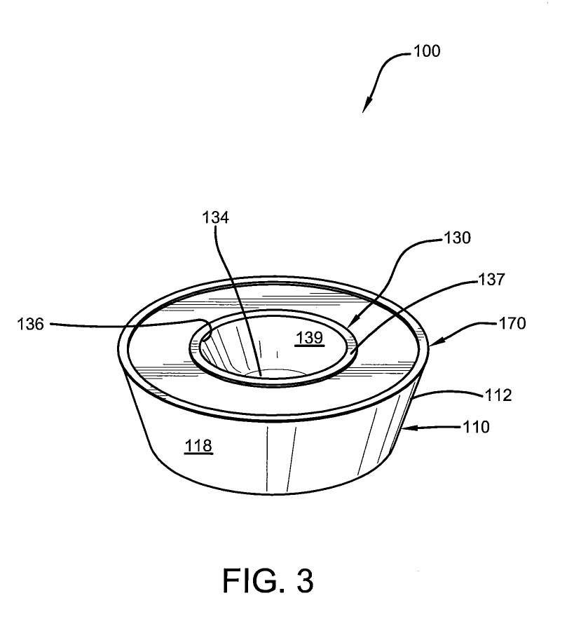

FIG. 4 illustrates a perspective view of a preferred embodiment of the insulated drinking bowl in a fully assembled condition and being utilized by an animal.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

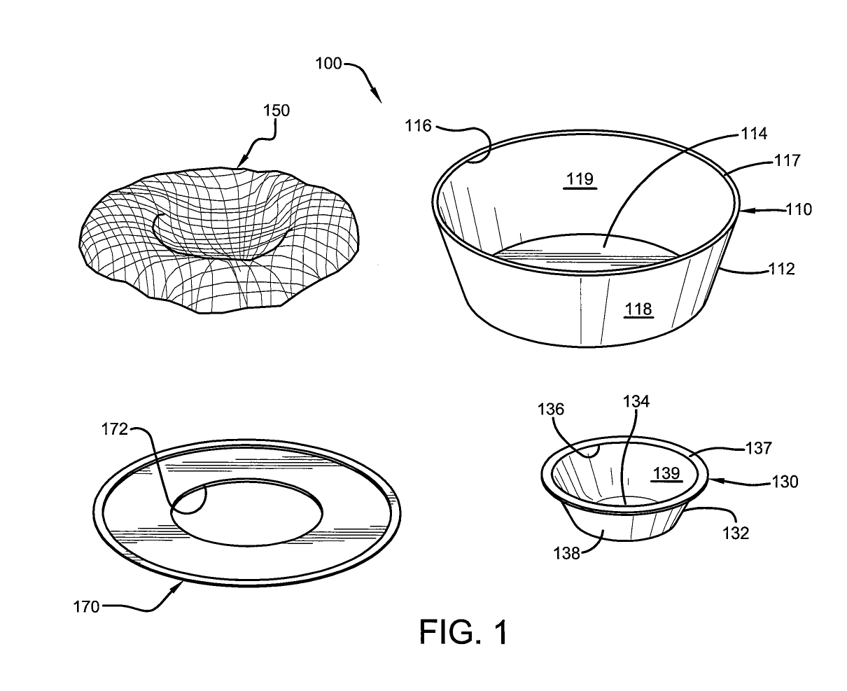

Referring initially to the drawings, FIG. 1 illustrates a perspective view of the various components of a preferred embodiment of the insulated animal drinking device 100 in a disassembled condition. Device 100 is preferably comprised of an outer container 110, an inner container 130, an insulating material 150 and a cover 170. Unless otherwise stated herein, each of the components of device 100 (with the exception of insulating materials 150) is preferably comprised of a durable material such as stainless steel, ceramic, polymers, or the like or a combination of said materials.

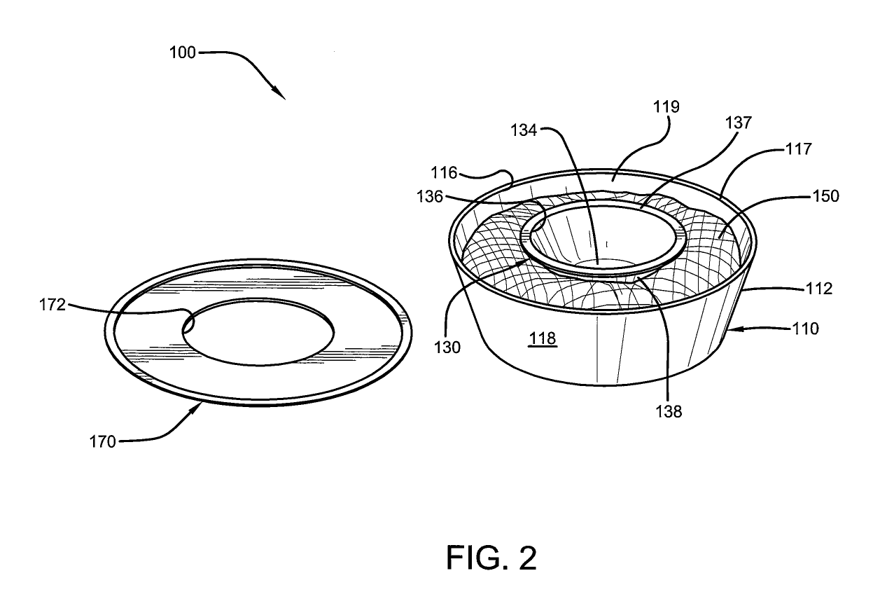

As best illustrated in FIGS. 1 and 2, outer container 110 is generally bowl-shaped and comprised of a wall 112, a bottom portion 114, and an interior space 116 formed by said wall 112 and bottom portion 114. Wall 112 further comprises a top 117, an exterior surface 118 and an interior surface 119. While the overall shape, dimensions and color of outer container 110 may vary to suit user preference or a particular application, the overall height of outer container 110, as measured between bottom portion 114 and top 117, is preferably between 8 and 24 inches, and the diameter of said outer container 110 at top 117 is preferably between 12 and 28 inches. Wall 112 may be generally perpendicular to bottom portion 114, or may extend outwardly from bottom portion 114 at an angle as best illustrated in FIG. 1.

As best illustrated in FIGS. 1 and 2, inner container 130 is also generally bowl-shaped and comprised of a wall 132, a bottom portion 134, and an interior space 136 formed by said wall 132 and bottom portion 134. Wall 132 further comprises a top 137, an exterior surface 138 and an interior surface 139. While the overall shape (e.g., inner container 130 may also be hemispherical in shape), dimensions and color of inner container 130 may vary to suit user preference or a particular application, the overall height of inner container 130, as measured between bottom portion 134 and top 137, is preferably between 2 and 10 inches, and the diameter of said inner container 130 at top 137 is preferably between 10 and 20 inches. Wall 132 may be generally perpendicular to bottom portion 134, or may extend outwardly from bottom portion 134 at an angle, as best illustrated in FIG. 1.

Insulating material 150 is preferably comprised of an organic material, such as hay, stray, wool, etc. Nonetheless, it is also contemplated that other materials, organic or inorganic, could also be used provided that the same have insulating properties (e.g., R-13 or greater is preferred but not required). For example, it is also contemplated that fiberglass or other known inorganic insulation materials 150 could also be used without affecting the overall concept of the invention.

As best illustrated in FIG. 2, inner container 130 is typically placed within the interior space of 116 of outer container 110 and insulating material 150 is placed around the exterior surface 138 of inner container 130. More specifically, insulating material 150 is placed between exterior surface 138 of wall 132 of inner container 130 and interior surface 119 of wall 112 of outer container 110. Cover 170, which is preferably complimentary in shape and size to outer container 110, may then be placed over top of outer container 110 to conceal insulating material 150 and prevent the same from being consumed by the animal utilizing device 100. This is particularly important when inorganic insulating materials 150 are being used, which could result in illness or death to the animal if ingested.

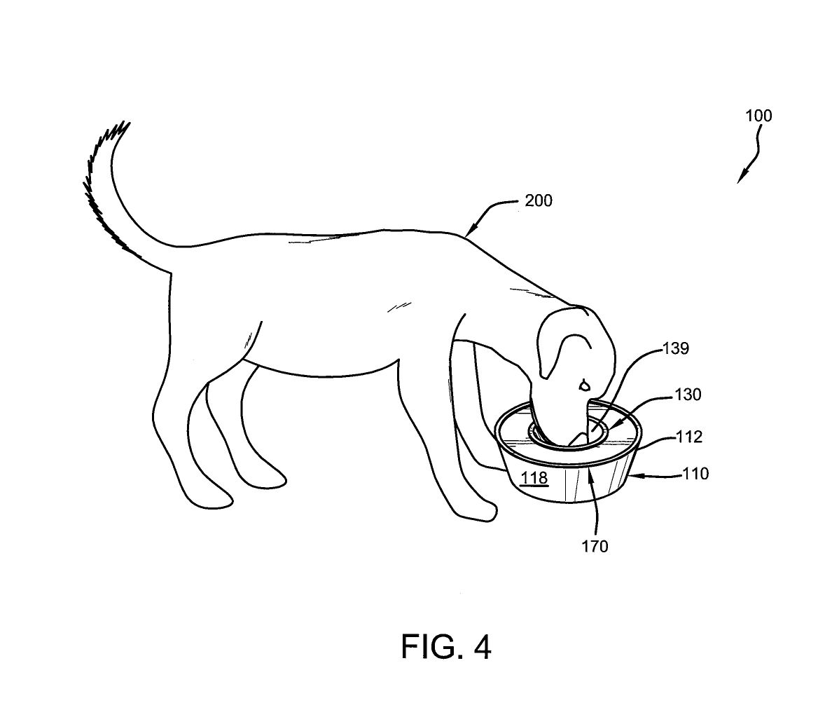

As best illustrated in FIG. 2, cover 170 is preferably further comprised of a continuous opening 172 therein that is complimentary in shape and size to inner container 130 so as to permit the animal (not shown) to have access to the contents of inner container 130. FIG. 4 illustrates a perspective view of a preferred embodiment of the insulated drinking bowl 100 in a fully assembled condition and being utilized by an animal 200.

Having now described the overall structure of device 100, the use and usefulness of the same will now be summarized. A user (not shown) desiring to prevent the contents of an animal bowl from freezing when utilizing the same in an environment with little or no artificial heat (e.g., outdoors, in an outbuilding, etc.) to feed and/or hydrate an animal can utilize insulated bowl device 100. The user (not shown) would simply insert the contents (e.g., food, liquid, etc.) into the interior space 136 of inner container 130 and place inner container 130 within outer container 110 on bottom 114. Alternatively, inner container 130 may be removably or fixedly attached to the bottom 114 of outer container 110 by any means commonly known in the art such as welding, through use of an adhesive, hook and loop fasteners, etc.

The user (not shown) may then place insulating material 150 between exterior surface 138 of wall 132 of inner container 130 and interior surface 119 of wall 112 of outer container 110. The insulating material 150 may be organic (e.g., hay, stray, wool, etc.), inorganic (insulation, etc.), or a mixture of both organic and inorganic materials provided that the same reduces the likelihood that the contents of inner container 130 will freeze. Cover 170, which is preferably complimentary in shape and size to outer container 110, may then be placed over top of outer container 110 to conceal insulating material 150 and prevent the same from being consumed by the animal utilizing device 100. As noted above, this is particularly important when inorganic insulating materials 150 are being used, which could result in illness or death to the animal 200 if ingested.

Consequently, the various embodiments of insulated bowl device 100 of the present invention described herein are useful for reducing the likelihood that the water or other liquid or food contained therein will freeze when stored in an outbuilding with little or no heat, which could result in the dehydration, starvation, illness or death of the animal. The insulated bowl device 100 is also eco-friendly, inasmuch it can be used with organic insulating materials, and is not dependent on electricity or some other external heating source, the use of which could be both expensive and dangerous. Further, the insulated bowl device 100 is portable, and is not constrained by power cords, fuel lines and the like. Finally, the insulated bowl device 100 is relatively inexpensive to manufacture, and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An animal drinking container comprising:
an outer container;
an inner container;
an insulating material; and
a cover.

2. The animal drinking container of claim 1 wherein said inner container is positioned within said outer container and at least a portion of said insulating material is positioned between the outer container and the inner container.

3. The animal drinking container of claim 1 wherein said cover is further comprised of a continuous opening therein.

4. The animal drinking container of claim 3 wherein said continuous opening is positioned over at least a portion of said inner container to permit access thereto.

5. The animal drinking container of claim 1 wherein the inner container is attached to the outer container.

6. The animal drinking container of claim 1 wherein said inner container further comprises an exterior surface and said outer container further comprises an interior surface, wherein at least a portion of the insulating materials is positioned between said interior surface and said exterior surface.

7. The animal drinking container of claim 1 wherein said insulating material is comprised of organic material.

8. The animal drinking container of claim 1 wherein said insulating material is comprised of inorganic material.

9. An animal container comprising:
an outer container having an inner space;
an inner container at least partially located within said inner space;
an insulating material also at least partially located within said inner space; and
a cover.

10. The animal container of claim 9 wherein at least a portion of said insulating material is positioned between the outer container and the inner container.

11. The animal container of claim 9 wherein said cover is further comprised of a continuous opening therein.

12. The animal container of claim 11 wherein said continuous opening is positioned over at least a portion of said inner container to permit access thereto.

13. The animal container of claim 9 wherein the inner container is attached to the outer container.

14. The animal container of claim 9 wherein said insulating material is comprised of organic material.

15. An animal container comprising:
an outer container comprised of a wall and a bottom that define an inner space;
an inner container comprised of an inner container wall and an inner container bottom that define an inner container inner space, wherein said inner container is attached to the bottom of said outer container;
an insulating material at least partially located within said inner space; and
a cover.

16. The animal container of claim 15 wherein at least a portion of said insulating material is positioned above the bottom and between the wall and the inner container wall.

17. The animal container of claim 15 wherein said cover is further comprised of a continuous opening therein.

18. The animal container of claim 17 wherein said continuous opening is positioned over at least a portion of said inner container inner space to permit access thereto.

19. The animal container of claim 15 wherein said insulating material is comprised of organic material.

20. The animal container of claim 15 wherein said insulating material is comprised of inorganic material.
